(19) United States
(12) Patent Application Publication
(10) Pub. No.: US 2013/0068738 A1
(43) Pub. Date: Mar. 21, 2013

(54) LASER CUTTING HEAD AND METHOD FOR CUTTING A WORKPIECE BY MEANS OF A LASER CUTTING HEAD

(71) Applicants: Burt Schürmann, Gernsbach (DE); Ingo Stork Genannt, Munchen (DE)

(72) Inventors: Burt Schürmann, Gernsbach (DE); Ingo Stork Genannt, Munchen (DE)

(73) Assignee: PRECITEC KG, Gaggenau-Bad Rotenfels (DE)

(21) Appl. No.: 13/697,341

(22) PCT Filed: May 3, 2011
(86) PCT No.: PCT/EP11/02211

§ 371 Date: Nov. 30, 2012

(30) Foreign Application Priority Data
May 11, 2010 (DE) 10 2010 020 183.9

(51) Int. Cl. B23K 26/38

(52) U.S. Cl. CPC B23K 26/38
USPC 219/121.72; 219/121.67

(57) ABSTRACT

The invention relates to a device (10, 32, 56) for cutting a workpiece (12) by means of a working laser beam (14), comprising a housing (16), through which a path is made for the working laser beam (14) and which has a focusing lens (18) for focusing the working laser beam (14) onto the workpiece (12) to be cut within a working area (48), a lighting device (44) with a light source (46) for the incoherent lighting of the working area (48) of the workpiece (12) to be cut, a camera (32), coupled coaxially into the path of the working laser beam, for observing the working area (48) of the workpiece (12) to be cut, wherein an optical filter, which is substantially opaque to the working laser beam (14), is arranged ahead of the camera (32) in the path of the observation beam (22), and comprising a processing unit (56), which is designed for processing image data from the camera (32), in order to determine the geometry and quality of a slit (50) produced in the workpiece (12) by the working laser beam (14), wherein the optical filter is an optical bandpass filter (36) and the light source (46) of the lighting device (44) is of such a nature that it has an at least local radiating maximum in the wavelength pass band of the bandpass filter (36), in order to make it possible for the camera (32) to record a grey-scale image of the working area (48) in which both reflections by the working laser beam (14) and emissions of the material vapour of the workpiece (12) are minimized.

The invention relates to a device or a laser cutting head for cutting a workplace by means of a working laser beam, and to a method for cutting a workplace by means of a laser cutting head.

In recent years, laser beam cutting has developed into a standard method in the manufacturing industry. In a laser beam cutting process, at a location where a focused laser beam strikes a workplace the material of the workplace, which is a metal, as a rule, is so strongly heated that it melts or vaporizes. As soon as the laser beam has completely penetrated the workplace, the cutting process can begin. The laser beam moves along a part contour and fuses the material continuously. The melt is mostly blown downward from the kerf by a gas stream. The result is a narrow cut slit between the subgrid and the remaining grid. The cut slit is scarcely wider than the focused laser beam itself. In the case of laser sublimation cutting, the input laser power is so large that the material vaporizes completely, and so no more material need be blown out from the cut slit.

A distinction is made between two standard methods of laser beam cutting, specifically flame cutting and fusion cutting. Flame cutting is predominantly used for cutting structural steel, oxygen being used here as cutting gas. The oxygen reacts with the heated metal, whereupon the latter undergoes combustion and oxidizes. In this case, the chemical reaction releases energy which goes to as far as five times the laser energy and supports the laser beam. This method can therefore be used to cut structural steel with thicknesses up to above 30 mm. However, the combustion process gives rise to cut edges that, on the one hand, are oxidized and, on the other hand, can have a rough surface.

By contrast, therewith, in the second standard method, fusion cutting, nitrogen or argon is used as cutting gas. In this method, the cutting gas is driven through the kerf at pressures between typically 2 and 20 bar. Argon is an inert gas. That is to say, it does not react with the fused metal in the cut slit, but it is merely blown out downward. At the same time, it protects the cut edge from the air. Nitrogen can also be used as cutting gas for almost all metals. The sole exception is titanium, which reacts strongly both with oxygen and with nitrogen and is therefore cut with argon. Fusion cutting has the great advantage that the edges remain unoxidized and no longer have to be reworked. However, only the energy of the laser beam is available for cutting, for which reason the cutting speeds are as high as in the case of flame cutting only in thin sheets.

It is usually CO₂ lasers, diode lasers, Nd:YAG lasers, solid state lasers or fiber lasers that are used in laser beam cutting operations. A fiber laser is a special form of solid state laser, a doped core of a glass fiber forming the active medium. At its end faces, the fiber laser has mirrors that form a resonator and therefore enable controlled laser operation. These reflecting surfaces comprise refractive index variations inscribed in the glass fiber with UV light, the so-called fiber Bragg gratings. Consequently, no additional coupling losses arise at these gratings and the latter selectively reflect only the desired wavelengths. Erbium is used most frequently as doping element for the laser-active fiber core, being followed by ytterbium and neodymium. The wavelengths of the laser light scarcely differ from one another, being at 1.06 μm (neodymium) and 1.03 μm (ytterbium). A great advantage of these fiber lasers is that the emitted optical wavelength is absorbed only very weakly by the glass, and so the emitted laser light can be led by means of a glass fiber from the laser device to a connected laser cutting head.

In known laser beam cutting processes, the optical emission of the material vapor or plasma produced when the working laser beam strikes the workplace is examined, in order to monitor the quality of the cutting operation. Thus, for example, a change in the emission spectrum, or the intensity of the plasma illumination are indicators for a good or poor laser cutting operation. Moreover, the material plasma of the workpiece to foe cut which arises during the cutting process can also be acquired capacitively, and evaluated by the distance sensor, which is designed as a rule to be integrated with the cutting nozzle. Photodiodes, which capture the process illumination without spatial resolution, and evaluate it, are used in the optical evaluation of the laser cutting operation.

DE 198 52 302 A1 describes a method and a device for machining workplaces with high energy radiation. In this case, a weld seam produced in a workpiece is monitored by means of a light line that is projected onto the workpiece, different seam geometries, for example notches, seam overfills, seam bulges or seam holes, leading to different light profiles. The light cutting device in this case projects a light fan in the shape of a lateral, conical surface onto the workpiece, the circular light Line being arranged around the machining beam. Special filters whose transmission rate rises from the inside out can be used to measure the light line. Consequently, only little light penetrates near the midpoint of the radius, that is to say the bright light radiation originating from the machining zone is shielded, while there is a higher transmission rate given large radii, and so even comparatively dark measuring light can be detected. Moreover, it is possible to use color filters whose transmission rate differs in magnitude for different wavelengths of the light as a function of the radius.

DE 10 2004 041 935 A1 describes a device for observing a laser machining process, and a device for regulating the laser machining process. A working laser beam is focused on a workplace by means of a focusing mirror in an interaction zone during a laser machining process. In order to enable the surface of a workpiece to be imaged with good quality in the region of the interaction zone in a coaxial fashion through the beam path, the device comprises a radiation sensitive receiver arrangement and an observation mirror that directs onto the receiver arrangement radiation which comes from a region of the interaction zone and is coupled out of a working beam path, the observation mirror substantially having the same imaging properties as the focusing mirror.

DE 10 2005 024 085 A1 describes a device for monitoring a laser machining operation and a laser machining head. In order to record the quality of a machining operation independently of process, a monitoring device comprises a radiation sensitive receiver arrangement having a radiation sensitive receiver and a camera for acquiring radiation from a region of an interaction zone between a laser beam and a workplace. The device further comprises an imaging device which images a region to be observed from the region of the interaction zone onto the receiver arrangement, and an evaluation circuit, to which output signals of the radiation sensitive receiver and the camera are fed simultaneously, and which processes the received output signals of the receiver arrangement in order, for its part, to supply output signals that characterize the course of the laser machining operation.

DE 101 20 251 A1 describes a method and a sensor device for monitoring a laser machining operation to be carried out on a workpiece, and a laser machining head having such a sensor device. In the method for monitoring a laser machining operation to be carried out on a workpiece, for the purpose of quality assurance a spatially resolving receiver arrangement is used to select a specific observation field in the region of the interaction zone between laser beam and workplace. The radiation coming from the selected observation field is acquired with the aid of a radiation-sensitive receiver that supplies an electric signal corresponding to the acquired radiation, and the electric signal is filtered in a signal processing circuit in order to detect fast and/or short, interference-induced changes in intensity of the acquired radiation, as a result of which it is possible to detect disturbances in the laser machining operation.

DE 3926859 A1 describes a method and a device for machining workpieces by means of laser radiation. In order to achieve in a simple way a controlled method without overshooting of a critical temperature, for example the vaporization temperature of the workpiece material, a radiation detector is used to measure the thermal radiation which emanates from a machining location and is used to monitor an upper temperature as upper limit value of a predetermined temperature range, and a lower temperature as lower limit value of this temperature range. Furthermore, the laser radiation is switched off when the upper limit value is reached, and switched on again when the lower limit value is reached.

WO 2009/047350 A1 describes a system and a method for monitoring a laser drilling method. This system comprises an illumination source and a processing unit. The illumination source illuminates a drilling area of a workpiece that is to be machined with the aid of the laser drilling device, and collects light from the illumination source that is reflected by the drilling area during the drilling process. By collecting the reflected light, the processing unit can determine the instant when the drilling operation is terminated. A CCD or CMOS camera is used to collect the light reflected by the workpiece. The illumination device is arranged laterally next to the laser drilling head, in order to illuminate the drill hole.

DE 10 2005 010 381 A1 describes a method for measuring phase boundaries of a material during machining of a workpiece with the aid of a machining beam, in particular with a laser beam, as well as a device, that is designed to carry out the method. In the method, during the machining a machining zone including the place of impingement of the machining beam on the workpiece is additionally illuminated with optical radiation in a fashion at least approximately coaxial with the machining beam. Radiation reflected by the machining zone is acquired with spatial resolution by an optical detector in a fashion parallel, or at a small angle, to a direction of incidence of the optical radiation, in order to obtain a reflection pattern of the machining zone. A profile of one or more phase boundaries in the machining zone is then determined from the optical reflection pattern.

It is the object of the invention to provide a device or a laser cutting head for cutting a workpiece by means of a working laser beam, and a method for cutting a workpiece by means of a device or a laser cutting head by which the cutting quality of a laser cutting process can be increased.

This object is achieved by the device as claimed in claim 1, and by the method as claimed in claim 15, Advantageous refinements and developments of the invention are set forth in the subclaims.

According to the invention, there is provided a device or a laser cutting head for cutting a workplace by means of a working laser beam, comprising a housing through which a beam path for the working laser beam is guided, and which has a focusing optics for focusing the working laser beam onto the workpiece to be cut within a working area, an illumination device with a light source for the incoherent illumination of the working area of the workpiece to be cut, a camera, coupled coaxially into the working laser beam path, for observing the working area of the workpiece to be cut, an optical filter that is substantially opaque to the working laser beam being arranged in the observation beam path upstream of the camera, and a processing unit that is designed to process image data from the camera in order to determine the geometry and the quality of a cut slit produced in the workpiece by the working laser beam, the optical filter being an optical bandpass filter and the light source of the illumination device being such that it has an at least local emission maximum in the wavelength passband of the bandpass filter, in order to enable the camera to record a grayscale image of the working area, in which both reflections by the working laser beam and emissions of the material, vapor of the workpiece are minimized.

It is advantageous here when the processing unit is designed to process image data from the camera in order to determine a current width of the cut slit.

According to the invention, there is further provided a device or a laser cutting head for cutting a workpiece by means of a working laser beam, which device or which laser cutting head comprises a housing through which a beam path for the working laser beam is guided, and which has a focusing optics for focusing the working laser beam onto the workpiece to be cut within a working area, an illumination device with a light source for the illumination, in particular a uniform illumination, of the working area of the workpiece to be cut, a camera, coupled coaxially into the working laser beam path, for observing the working area of the workpiece to be cut, an optical filter that is substantially opaque to the working laser beam being arranged in the observation beam path upstream of the camera, and a processing unit that is designed to process image data from the camera in order to determine the width of a cut slit produced in the workpiece by the working laser beam.

Thus, there is provided a device or a laser cutting head for cutting a workpiece by means of a working laser beam, which device or which laser cutting head illuminates uniformly by means of an illumination device a working area of the workpiece, that is to say the area in which the working laser beam in the interaction zone enters the workpiece and penetrates it so as to produce a cut slit. A camera coupled coaxially into the working laser beam collects the light that is generated by the illumination device and strikes the workpiece. The recorded image is evaluated by means of a processing unit, to the effect that a width of the cut slit produced is determined. The determination of the cut slit width is preferably performed directly after the production of the slit, that is to say in an area of approximately 10 mm downstream, of the striking point or penetration point of the working laser beam.

A direct conclusion concerning the quality of the cut slit can be drawn via the optical determination by means of a spatially resolving camera of the cut slit width. Moreover, by prescribing an optimum cut slit width value of the laser cutting operation can be regulated to this prescribed cut slit width, the result being to ensure an optimized laser cutting operation. The feed rate, the cutting gas pressure, the focal position and the laser beam power can be used as regulating parameters for this purpose.

On the basis of the coaxial coupling of the camera into the laser beam path, observation of the laser cutting operation is performed directly from above into the cut slit, that is to say perpendicular to the workpiece surface and parallel to the working laser beam. Since the fused material is substantially blown out downward parallel to the working laser beam, interfering light emissions from the fused material, or material vapor, that is produced are lowest in a direction coaxial with the working laser beam, which substantially coincides with the blowout direction through the cutting nozzle. This means to say, then, that because of the coaxial arrangement of the camera, in conjunction with an optical cutout of the wavelength of the working laser beam by an optical filter, it is therefore possible to minimize both interfering reflections caused by the working laser beam, and interfering emissions of the material vapor, so that in accordance with the invention the slit width can be determined by the camera on the basis of the extraneous illumination by the illumination device, and can be used for a regulating operation of the laser cutting process.

In order to be able to blow the material of the workpiece that is fused by the working laser beam downward out of the cut slit by means of a cutting gas, it is expedient when the device or the laser cutting head has a cutting nozzle through which the working laser beam and the observation beam path of the camera run and through which a cutting gas is led.

For simple correction of the observation beam path of the camera with regard to the working area of the workpiece to be cut, it is expedient when the device or the laser cutting head has a first beam splitter by which the observation beam path of the camera can be coupled coaxially into the laser beam path.

For a compact arrangement of the illumination device in the device or the laser cutting head, it is expedient when the device or the laser cutting head has a second beam splitter, which is arranged in the observation beam path between the first beam splitter and the camera, by which the illumination of the illumination device can be coupled coaxially into the laser beam path.

It is, however, also conceivable to fasten the illumination device on an outer side of the housing in order to illuminate the working area of the workpiece uniformly.

In accordance with a particularly preferred refinement of the invention, the light source of the illumination device is configured such that its emitted optical radiation lies in a very narrow wavelength region so that, given the use of an optical bandpass upstream of the observation camera, said light source can be observed by said observation camera and, consequently, interfering radiation is virtually eliminated in the operation of the laser cutting head.

For a real implementation of the optical bandpass filter, the latter is expediently an interference filter, in particular a Fabry-Perot filter, wherein the half value width of the wavelength passhand is smaller than 50 μm, in particular smaller than 20 μm.

For a simple implementation of the illumination of the workpiece, it is expedient when the light source of the illumination device is a xenon flash lamp or a mercury vapor lamp.

Because of the possibility of simple adaptation of an emission wavelength, it is advantageous when the light source of the illumination device is at least an LED, in particular an RCLED, or at least a laser.

However, it is also conceivable for the light source of the illumination device to have at least one laser and, on the beam outlet side thereof, a temporally varying diffuser through which the laser light generated by the laser runs, in order to dissolve the coherence of the laser light.

Moreover, the light source of the illumination device can have a multiplicity of lasers whose laser light is superposed such that the resulting illumination of the illumination device gives rise to incoherent light.

The camera used expediently comprises an image recording device which is designed to process the image data by means of an HDR method.

In an inventive refinement of the device or the laser cutting head, said device or head further has a control unit that is designed to set process parameters, such as cutting gas pressure or feedrate of the laser cutting head during a laser cutting process such that the width of the cut slit is regulated to a prescribed value.

According to the invention, there is further provided a method for laser beam cutting a workpiece which uses the inventive device or the laser cutting head. In this method, a grayscale image of the working area of the workpiece to be cut is recorded with the camera, and the current width of the cut slit is determined by a processing unit at a predetermined distance from the interaction zone between working laser beam and workpiece.

Given use for a regulating process, a control unit acquires process parameters such as cutting gas pressure, feedrate, focal position and laser beam power of the device or of the laser cutting head, and sets these process parameters, in order to control or to regulate the current width of the cut slit to a prescribed value.

The invention is explained in more detail below with the aid of the drawings, in which:

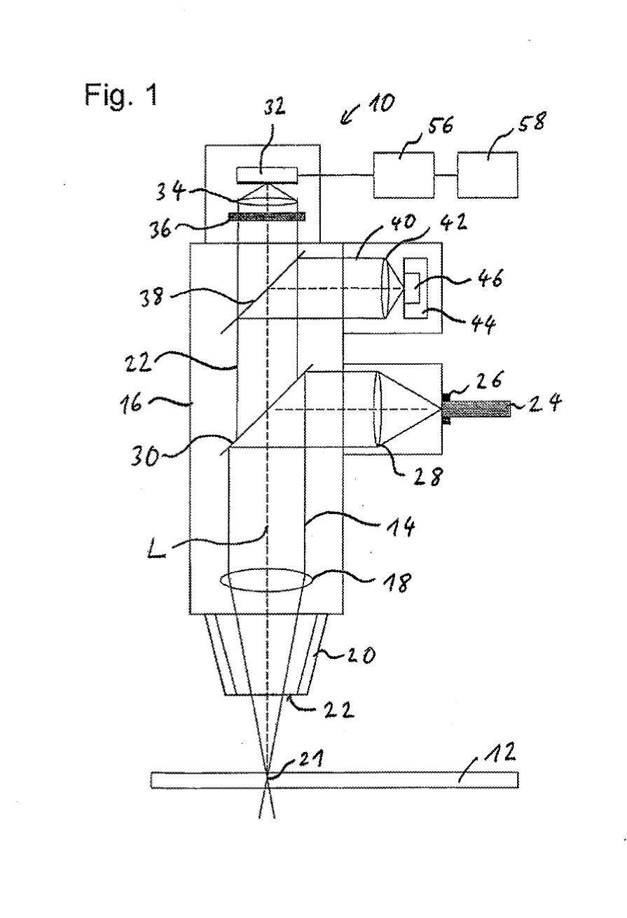

FIG. 1 shows a greatly simplified schematic view of a laser cutting head in accordance with a first exemplary embodiment of the invention,

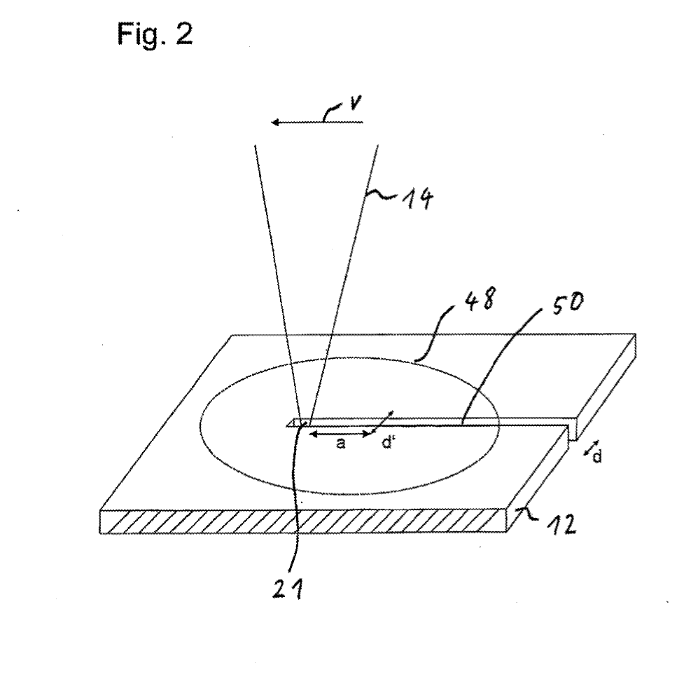

FIG. 2 shows a greatly simplified perspective partial view of the workpiece during a laser cutting process, and

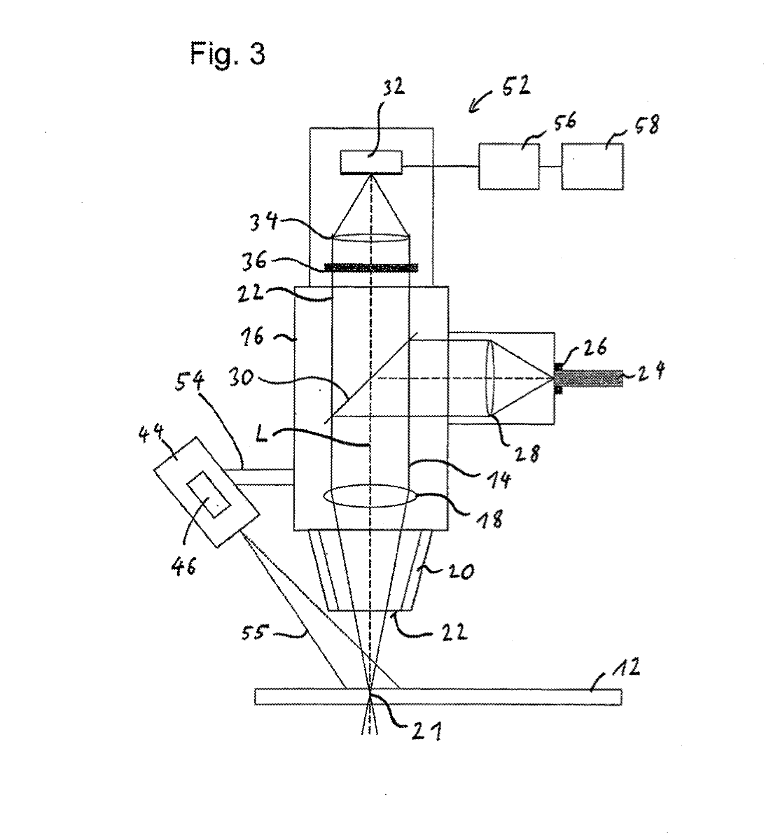

FIG. 3 shows a greatly simplified schematic view of a laser cutting head in accordance with a second exemplary embodiment of the invention.

Mutually corresponding components are provided with the same reference symbols in the various figures of the drawings.

FIG. 1 shows a greatly simplified view of a laser cutting head 10 in accordance with a first exemplary embodiment of the invention in the way used with laser processing machines or systems.

In order to cut the workpiece 12, a working laser beam 14 coming from the laser processing machine is directed through a housing 16 of the laser cutting head 10 onto the workpiece 12 and, as indicated by the optical axis L, focused onto the workpiece 12 through a cutting nozzle 20 by means of a focusing optics 18. The laser light, focused in the region of the workpiece 12, of the working laser beam 14 fuses material in an interaction zone 21 in the workpiece 12, which material is blown downward out of the workpiece 12 by a process gas stream that is guided through the cutting nozzle 20 in the direction of the workpiece 12. The dimensions of the nozzle 20 are illustrated with exaggeration: in a real implementation, the opening 22 of the cutting nozzle 20 is substantially closer to the surface of the workpiece 12 in order, for example, to carry out a capacitive distance regulation and, moreover, to be able to exert an appropriate cutting gas pressure on the workpiece 12. It is, however, also conceivable not to use any cutting nozzle in a sublimation cutting process, in which the material is completely vaporized.

The working laser beam 14 is fed to the laser cutting head 10 through an optical fiber 24, the fiber end of the optical fiber 24 being held in a fiber holder 26. The laser beam 14 emerging at the fiber end of the optical fiber 24 is collimated by means of a collimating optics 28 and directed onto a first beam splitter 30 that deflects the laser beam 14 in the direction of the focusing optics 18.

The arrangement of the collimating optics 28 and the optical fiber 24 relative to the focusing optics 18 is, however, not restricted to the example shown in FIG. 1; it is also possible for the laser beam 14 widened by the collimating optics 28 to rim straight along the optical axis L to the focusing optics 18. In this case, the beam splitter 30 is designed so that it passes a majority of the laser radiation striking it (in this case, the components for illuminating and observing the workpiece 12 are arranged at the location at which the collimating optics 28 are mounted in FIG. 1), whereas in the case first described the beam, splitter 30 reflects a majority of the radiation striking it. The first beam splitter 30 can also be a dichroic mirror that is tuned to the wavelength of the working laser beam 14 such that it substantially fully reflects the working laser beam 14 and is substantially transparent to a residual wavelength region. The first beam splitter 30 can therefore function as optical filter that does not pass the working laser beam 14 into the observation beam path 22.

The first beam splitter 30 is arranged in the passband of the working laser beam 14 in the housing of the laser cutting head 10 so that an observation beam path 22 (indicated by its optical axis) of a camera 32 is coaxially coupled into the beam path of the working laser beam 14. Arranged in the observation beam path 22 upstream of the camera 32 are an imaging optics 34 and an optical bandpass filter 36 that will be described below yet more exactly.

Arranged in the observation beam path 22 between the first beam splitter 30 and the optical bandpass filter 36 is a further, second beam splitter 38 through which an illumination beam path 40 (indicated by its optical axis) is coupled coaxially, by means of an optics 42 from an illumination device 44 into the observation beam path 22, and thus into the beam path of the working laser beam 14.

The illumination device 44 has a light source 46 for generating the illumination light. The light source 46 of the illumination device 44 is provided for the purpose of illuminating a working area 48 on the workpiece 12 in which the working laser beam 14 strikes the workpiece 12 and penetrates the latter in the interaction zone 21 in order to produce a cut slit 50 in the workpiece 12, as is shown in FIG. 2. Here, the illumination is preferably performed uniformly, but all that is presupposed for the invention is that the cut-slit geometry can be adequately acquired.

By way of example, what are suitable as light sources for use as light source 46 are semiconductor light emitting diodes or LEDs, which are provided with an optical resonator, the result being to amplify the spontaneous emission of the light emitting diode by the optical resonator. Unlike normal semiconductor light emitting diodes, these so-called RCLEDs (resonant cavity light emitting diodes) have, a greatly narrowed emission spectrum with a half value width or FWHH (full width at half maximum) of approximately 5 to 10 μm. However, by way of example it is also conceivable to use xenon flash lamps or mercury vapor lamps with a high emission intensity, the wavelength region being appropriately restricted by filters.

A further possible light source that can be used as light source 46 of the illumination device 44 is a laser light source. The laser light source is a laser whose beam is expanded such that the laser light illuminates the working area 48 together with the cut slit 50. As a rule, upon illumination of the surface of the workpiece 12, a so-called speckle pattern or a granulation occurs here, which, given a coherent illumination of the. generally optically rough surface (unevennesses of the order of magnitude of the wavelength of the laser light) of the workpiece 12, becomes visible in the far field of the reflected light when said workpiece is imaged on a camera. However, it is possible to use coherent light as long as the course of the cut slit 50 or its width can be adequately detected.

However, if this speckle pattern causes too strong an interference, to minimize this effect it is possible either to resolve the coherence of the laser light or to reduce the speckle contrast by a sufficiently fast temporal variation of the speckle interferences within the integration time of the eye or the camera 32. Here, for example, the laser light of the light source 46 can be led through a rotating diffuser (not shown). By way of example, a glass plate with a rough surface is suitable as diffuser. If the diffuser is located at the focus of the laser beam of the light source 46, statistical phase variations are introduced into the beam, while the spatial coherence is maintained. If the unfocused beam is led through the diffuser, both the spatial and the temporal coherence are resolved.

A further possibility for resolving the coherence of the laser light of the light source 46 resides in the superposition of laser light from a multiplicity of different lasers, the resulting illumination of the illumination device 44 no longer having any coherence effects, and a speckle pattern on a surface of the workpiece 12 being avoided.

The preferred emission wavelength of the light source 46 of the illumination device 44 lies in a wavelength region between 630 nm and 670 nm, an intensity maximum of the light source 46 being expedient at 640 nm, for example.

The wavelength passband of the optical bandpass filter 36 arranged upstream of the camera 32 is preferably adapted to an at least local emission maximum of the light source 46 of the illumination device 44, Here, the half value width or FWHM (full width at half maximum) of the wavelength passband of the filter 36 is to be selected such that precisely the emission maximum of the light source 46 lies inside the passband of the optical bandpass filter 36. The half value width is preferably smaller than 100 nm, preferably smaller than 50 nm and, in particular, smaller than 20 nm. The optical bandpass filter 36 is preferably a Fabry-Perot filter or a Fabry-Perot etalon, this type of filter passing electromagnetic waves of a specific frequency range and extinguishing the remaining frequency components by interference. With regard to the half value width of the optical bandpass filter 36, it is advantageous when this region is as low as possible in order, when operating the laser cutting head 10, to cause as little interference as possible in the camera image on the basis of reflections of the working laser beam 14, or on the basis of the thermal radiation of the cutting vapor torch, which results from the cutting operation of the workpiece 12 by means of the working laser beam 14 through vaporization of the workpiece material. However, instead of the optical bandpass filter 36 it is also conceivable to provide an optical filter that is substantially opaque to the working laser beam.

Thus, by tuning the light source 46 of the illumination device 44 to the passband of the optical bandpass filter 36 it is possible to arrange for the workpiece 12 to be uniformly illuminated, the image of the camera 32 not being disturbed because of the narrow observed wavelength region even in the event of the working laser beam 14 being switched on. Moreover, according to the invention it is possible to provide elimination of further interferences in the recording of the camera 32 of the workpiece surface 12 illuminated by the light source 46 by modulation of the intensity of the light source 46 and subsequent correlation in the case of detection by the camera 32, that is to say by using a lock-in method.

The camera 32 can be designed as CMOS camera or CCD camera, according to the invention this preferably comprising an image recording device that is designed to process the image data by means of an HDR method. In this method, different images are produced by multiple scanning of an imaging sensor or by simultaneous image recording with a plurality of cameras, or by sequential image recording with one camera, but with different exposure time, this being termed multiple exposure technique. The correction of the individual recorded images can comprise various types of method. These include, in the simplest case, the summing and determination of the individual image values of a plurality of images of an image sequence from at least two recorded images. For the purpose of better image recovery, the image values or pixels can be determined from an image sequence composed of at least two images recorded in weighted fashion. As weighting method, it is possible either to use an entropy method for weighting by information content, or it is possible to make a weighted determination by taking account of the camera response function. This procedure enables the recording of images and image sequences or videos with an extremely high dynamic range, and so light and dark areas of the workpiece can be dissolved simultaneously. Consequently, this means that both reflecting and matt areas of the workpiece surface can be recorded simultaneously.

FIG. 3 illustrates a laser cutting head 52 in accordance with a second exemplary embodiment of the invention. The laser cutting head 52 of the second exemplary embodiment corresponds substantially to the laser machining head 10 shown in FIG. 1, although only the camera 32, the imaging optics 34 and the optical bandpass filter 36 are situated directly opposite the first beam splitter 30, the result being that the observation beam path 22 is coupled directly into the beam path of the working laser beam 14. In this case, the illumination device 44 is fitted on the housing 16 via a holder 54, the result being that the illumination of the working area of the workpiece 12 is not performed coaxially with the working laser beam 14, but by a light cone 55 impinging laterally thereto. Since, in a laser cutting operation, the nozzle 20 is guided along very near the workpiece 12 as a rule, however, the embodiment according to FIG. 1 is preferred because it is possible in the arrangement shown in FIG. 2 for the light generated by the light source 46 to be shaded by the cutting nozzle 20. The arrangement of the illumination device 44 is, however, not restricted to the embodiments shown in FIG. 1 and FIG. 2. Thus, for example, illumination may also be done by an illumination device that is not connected to the laser cutting head 10 or 52. By way of example, therefore, it is conceivable to illuminate a side of the workpiece 12 that is opposite the laser cutting head 52. In this case, the slit 50 produced by the working laser beam 14 appears bright, since light shining onto the workpiece 12 from below penetrates the cut slit 50.

The aim below is to describe the function of the laser-machining head 10 from FIG. 1 and of the laser machining head 52 from FIG. 2. As shown in FIGS. 1 and 2, the camera 32 is connected to a processing unit 56 that is connected, in turn, to a control unit 58 via a data line.

During an inventive laser cutting operation, the image data, recorded by the camera 32, of the working area 48 with the cut slit 50 that is produced can be used to regulate the laser cutting operation so that a current width d′ of the cut slit 50 is regulated to a prescribed value d (FIG. 2). However, it is also conceivable according to the invention to monitor only the current width d′ of the cut slit 50 in order to detect faults in a laser cutting process. Finally, the value of the width ′ can be passed to a complex control device that uses a multiplicity of parameters to regulate, monitor or control a laser cutting process.

In order to carry out a regulation or monitoring process, the processing unit 56 uses digital image processing to evaluate the grayscale images recorded by the camera 32 so as to determine the current width d′ of the cut slit 50. The determination of the width d′ of the cut slit 50 is preferably performed immediately after production of the cut slit, that is to say at a distance a of less than 50 mm, preferably less than 30 mm, and, in particular, less than 10 mm downstream, of the interaction zone 21, that is to say downstream of the penetration point of the laser beam 14 through the workpiece 12. The width of the cut slit 50 is therefore the length of the perpendicular through the darkly appearing slit 50 at a predetermined distance a from the interaction zone 21. The value of the width of the cut slit 50 can be specified in pixels of the camera sensor or by calibration in mm. However, it is also possible, and even preferred, to measure the current width d′ directly in the interaction zone 21 (in which case a=0). The current value d′ of the width of the cut slit 50 is regulated to the prescribed value d by the use of actuators. By way of example, the regulating parameters used to set a uniform cut slit width d can be the cutting gas pressure of the cutting gas that emerges through the nozzle 20 in the direction of the workpiece 12, or the feedrate v of the laser cutting head 10 or 52. Further process parameters are, for example, the distance of the laser cutting head 10 or 52 from the workpiece surface, that is to say the focal position of the laser beam 14 inside the workpiece 12, or the laser beam power. It is also possible to use a learning operation by neural networks during the laser cutting operation, a multiplicity of process parameters being recorded by the control unit 58 and corresponding learned actuator operations being carried out in order either to keep the cut slit width to an optimum value d or, generally, to execute an optimized laser cutting process.

Thus, according to the invention the method for cutting a workpiece by means of the inventive laser cutting head comprises the steps of recording a grayscale image of the working area 48 by the camera 32, and of determining the current width d′ of the cut slit 50 on the basis of the grayscale image, recorded by the camera 32, of the working area 48 at a predetermined distance a from the interaction zone 21 between workpiece 12 and working laser beam 14, or directly in the interaction zone 21 itself. A regulation process based on this method comprises the acquisition of current process parameters such as cutting gas pressure, feedrate, focal position or laser power of the laser cutting head 10, 52, and the setting of the process parameters by the control unit 58 in order to control and, in particular, to regulate the current width d′ of the cut slit 50 to a prescribed value d.

The invention provides a device or a laser cutting head and a method for cutting a workpiece by means of a device or of a laser cutting head in the case of which device or head no use is made of a process illumination or reflections of the working laser beam in order to assess the quality of a laser machining operation, but in the case of which device or head the workpiece surface is illuminated with extraneous light and is recorded by a camera in order to determine from the recorded image data the slit geometry and, in particular, the slit width. The determined slit width can then be regulated to a prescribed value in order to enable an improved laser cutting operation. However, it is also possible to use the determined slit width as control value for the monitoring of the laser cutting operation, or to have the determined slit width value input into a control process.

1. A device for cutting a workpiece by means of a working laser beam, comprising
a housing through which a beam path for the working laser beam is guided, and which has a focusing optics for focusing the working laser beam onto the workpiece to be cut within a working area,
an illumination device with a light source for the incoherent Illumination of the working area of the workpiece to be cut,
a camera, coupled coaxially into the working laser beam path, for observing the working area of the workpiece to be cut, an optical filter that is substantially opaque to the working laser beam being arranged in the observation beam path upstream of the camera, and
a processing unit that is designed to process image data from the camera in order to determine the geometry and the quality of a cut slit produced in the workpiece by the working laser beam,
the optical filter being an optical bandpass filter and the light source of the illumination device being such that it has an at least local emission maximum in the wavelength passband of the bandpass filter in order to enable the camera to record a grayscale image of the working area, in which both reflections by the working laser beam and emissions of the material vapor of the workpiece are minimized.

2. The device as claimed in claim 1, wherein the processing unit is designed to process image data from the camera in order to determine a current width (d′) of the cut slit.

3. The device as claimed in claim 1, further comprising a cutting nozzle through which the working laser beam aid the observation beam path of the camera run and through which a cutting gas is led, as a result of which during a cutting operation a material of the workpiece to be cut that is fused by the working laser beam is blown downward from the cut slit.

4. The device as claimed in claim 1, further comprising a first beam splitter by which the observation beam path of the camera can be coupled coaxially into the working laser beam path,

5. The device as claimed in claim 4, further comprising a second beam splitter, which is arranged in the observation beam path between the first beam splitter and the camera, by which the illumination of the illumination device can be coupled coaxially into the working laser beam path.

6. The device as claimed in claim 1, wherein the illumination device is fastened on an outer side of the housing in order to illuminate the working area of the workpiece uniformly.

7. The device as claimed in claim 1, wherein the optical bandpass filter is an interference filter, in particular a Fabry-Perot filter.

8. The device as claimed in claim 1, wherein the optical bandpass filter has a wavelength passband whose half value width is smaller than 50 nm, in particular smaller than 20 nm.

9. The device as claimed in claim 1, wherein the light source of the illumination device is a xenon flash lamp or a mercury vapor lamp.

10. The device as claimed in claim 1, wherein the light source of the illumination device is at least an LED, in particular an RCLED, or at least a laser.

11. The device as claimed in claim 1, wherein the light source of the illumination device has at least one laser and, on the beam outlet side thereof, a temporally varying diffuser through which the laser light generated by the laser runs, in order to ressolve the coherence of the laser light.

12. The device as claimed in claim 1, wherein the tight source of the illumination device has a multiplicity of lasers whose laser light is superposed such that the resulting illumination of the illumination device gives rise to incoherent light.

13. The device as claimed in claim 1, wherein the camera comprises an image recording device which is designed to process the image data by means of an HDR method.

14. The device as claimed in claim 1, farther comprising a control unit that is designed to set process parameters, such as cutting gas pressure and feedrate of the device during a cutting process such that the current width (d′) of the cut slit is regulated to a prescribed value (d).

15. A method for cutting a workplace by means of a device as claimed in claim 1, comprising the steps of
recording a grayscale image of the working area by the camera, and
determining the current width (d′) of the cut slit on the basis of the grayscale image of tire working area recorded by the camera.

16. The method as claimed in claim 15, further comprising the steps of:
acquiring current process parameters of the device, such as cutting gas pressure, feedrate, focal position and laser beam power of the device, and
setting the process parameters in order to control or to regulate the current width (d′) of the cut slit to a prescribed value (d).
